(19) United States
(12) Patent Application Publication
(10) Pub. No.: US 2007/0062977 A1
(43) Pub. Date: Mar. 22, 2007

(54) Container for fluid susbtances like pastes or creams

(76) Inventor: Enzo Ferrarin, Bolzano (IT)

Correspondence Address: PEARNE & GORDON LLP, 1801 EAST 9TH STREET, SUITE 1200, CLEVELAND, OH, 44114-3108, US

(21) Appl. No.: 10/532,844

(22) PCT Filed: Oct. 29, 2002
(86) PCT No.: PCT/IT02/00688

§ 371 Date: Nov. 21, 2005

(51) Int. Cl. G01F 11/00; B65D 35/14

(52) U.S. Cl. 222/386; 222/107

(57) ABSTRACT

The object of the present invention is to create a container for substances capable of flowing, such as pastes or lotions, which allows, extremely simple and rapid fashion, the outflow of the substance capable of flowing contained therein and that at the same time also allows to be completely emptied of its content.

### TECHNICAL FIELD

The present invention relates to a container for substance capable of flowing such as pastes and lotions, i.e. substances that, while having a volume of their own, take on the shape of the container wherein they are located, according to the preamble to claim 1.

An example of such containers are tubes for toothpaste, for cosmetic lotions, for personal cleanliness or hygiene as well as tubes for medications and medical lotions. Also included are tubes for foods, such as mustard or mayonnaise, for industrial pastes, such as gel and grease.

### BACKGROUND ART

Currently, the person who wants to pour from the container the paste or lotion contained therein removes the closure element and presses with his/her fingers on the deformable hollow body. In this way, the paste or lotion contained therein is pressurised and thereby forced to flow out of the entry and exit opening.

This type of known containers, however, has the drawback that the outflow of the paste or lotion is very laborious, in particular when a considerable part of the paste or lotion had already been poured out in previous uses. In this case it is necessary carefully to press on the whole surface of the tube, starting from the lower end and moving up towards the entry and exit conduit, in order progressively to transfer all residual lotion or paste into the area of the body that is proximate to the entry and exit conduit.

An additional drawback of this type of known containers consists of the fact that on the inner walls of the hollow body and in the area in proximity with the entry and exit conduit of the hollow body there inevitably remain paste or lotion residues, which cannot be made to flow out in any way at all. Therefore, it is not possible completely to empty the hollow body, and hence it is impossible to use all the paste or lotion originally present in the container. This fact, in particular in case of high quality and high cost lotions or pastes such as those relating to cosmetics, health or hygiene, causes unacceptable wastage.

### DISCLOSURE OF INVENTION

The object of the present invention is to create a container for substances capable of flowing, such as pastes or lotions, which allows, extremely simple and rapid fashion, the outflow of the substance capable of flowing contained therein and that at the same time also allows to be completely emptied of its content.

This object is achieved by a container having the characteristics of claim 1.

The thrusting organ provided by the present invention prevents, during its progressive rise along the hollow body towards the entry and exit conduit, the substance capable of flowing from being dispersed, keeps it compact and progressively conveys it towards the entry and exit conduit, preventing residues of substance capable of flowing from remaining in the part of the hollow body that lies below it.

### DESCRIPTION OF THE DRAWINGS

Further advantages and details of the invention are shown below on the basis of embodiments and with reference to the figures of the accompanying drawings, in which:

FIGS. 1a and 1b respectively show a first and second longitudinal section, mutually offset by 90° and taken at distinct times, of a first embodiment of a container according to the invention relatively to a first example of thruster organ,

FIGS. 1c, 1d and 1e respectively show a top view and a first and second lateral view of only the thruster organ shown in the FIGS. 1a and 1b,

FIGS. 2a and 2b respectively show a first and second longitudinal section, mutually offset by 90° and taken at distinct times, of a second embodiment of a container according to the invention relatively to a second example of thruster organ,

FIGS. 2c, 2d and 2e respectively show a top view and a first and second lateral view of only the thruster organ shown in the FIGS. 2a and 2b,

FIGS. 3a and 3b respectively show a first and second longitudinal section, mutually offset by 90° and taken at distinct times, of a third embodiment of a container according to the invention relatively to a third example of thruster organ,

FIGS. 3c, 3d and 3e respectively show a top view and a first and second lateral view of only the thruster organ shown in the FIGS. 3a and 3b,

FIGS. 4a and 4b respectively show a first and second longitudinal section, mutually offset by 90° and taken at distinct times, of a fourth embodiment of a container according to the invention relatively to a fourth example of thruster organ,

FIGS. 4c, 4d and 4e respectively show a top view and a first and second lateral view of only the thruster organ shown in the FIGS. 4a and 4b,

FIGS. 5a and 5b respectively show a first and second longitudinal section, mutually offset by 90° and taken at distinct times, of a fifth embodiment of a container according to the invention relatively to a fifth example of thruster organ,

FIGS. 5c, 5d and 5e respectively show a top view and a first and second lateral view of only the thruster organ shown in the FIGS. 5a and 5b,

FIGS. 6a and 6b respectively show a first and second longitudinal section, mutually offset by 90° and taken at distinct times, of a sixth embodiment of a container according to the invention relatively to a sixth example of thruster organ,

FIGS. 6c, 6d and 6e respectively show a top view and a first and second lateral view of only the thruster organ shown in the FIGS. 6a and 6b,

FIGS. 7a and 7b respectively show a first and second longitudinal section, mutually offset by 90° and taken at distinct times, of a seventh embodiment of a container according to the invention relatively to a seventh example of thruster organ,

FIGS. 7c, 7d and 7e respectively show a top view and a first and second lateral view of only the thruster organ shown in the FIGS. 7a and 7b,

FIGS. 8a and 8b respectively show a first and second longitudinal section, mutually offset by 90° and taken at distinct times, of an eighth embodiment of a container according to the invention relatively to an eighth example of thruster organ,

FIGS. 8c, 8d and 8e respectively show a top view and a first and second lateral view of only the thruster organ shown in the FIGS. 8a and 8b,

FIGS. 9a and 9b respectively show a first and second longitudinal section, mutually offset by 90° and taken at distinct times, of a ninth embodiment of a container according to the invention relatively to a ninth example of thruster organ,

FIGS. 9c, 9d and 9e respectively show a top view and a first and second lateral view of only the thruster organ shown in the FIGS. 9a and 9b.

### DESCRIPTION OF THE ILLUSTRATIVE EMBODIMENTS

The figures schematically show a container for substances capable of flowing 2, such as pastes or lotions, i.e. substances that, while having a volume of their own, take on the shape of the container wherein they are located.

Such a container could be a tube, for instance a tube for toothpaste, for cosmetic lotions or for personal hygiene lotions as well as tubes for medications and medical lotions. Also included are tubes for foods, such as mustard or mayonnaise, for industrial pastes, for gels and for grease.

As the figures show, the container comprises a deformable hollow body 1, within which is placed the substance 2 capable of flowing, such as a paste or a lotion. The hollow body 1 is provided with an entry and exit conduit 3 at the end of which is present an entry and exit opening 4.

The container further comprises a closure element 5. The closure element 5 is able to be joined to the entry and exit conduit 3, to prevent the paste or lotion 2 from flowing out through the entry and exit opening 4.

According to the invention the container further comprises also a thruster organ 6, positioned in the hollow body 1 in such a way that the paste or lotion 2 is in the space between the entry and exit opening 4 and the thruster organ 6. This is obtained by positioning the thruster organ 6 at the end of the hollow body 1 opposite the one with the exit and entry opening 4.

The thruster organ 6 is positioned without constraints in the hollow body 1 and hence is able to slide under an external thrusting action, exerted on the hollow body 1 by a person's fingers.

Thereupon, the paste or lotion 2 is thrust by the thruster organ 6 towards the entry and exit opening 4.

Conveniently, the thruster organ 6 has multiple parts: an upper part 6a, a central part 6b and a lower part 6c.

The upper part 6a is in contact with the overlying paste or lotion 2 and has maximum cross section equal to that of the hollow body 1. This upper part 6a thrusts the paste or lotion 2 and conveys it.

The central part 6b has constant cross section, equal to that of the hollow body 1 and on its surface is positioned in annular fashion a band 7. This band 7 is able to scrape, during the sliding of the thruster organ 6, on the inner surface of the hollow body 1 and prevents residues of paste or lotion 2 from remaining, during the sliding of the thruster organ 6, in the empty part of the hollow body 1, the one between the thruster organ 6 and the lower end of the container.

Lastly, on the lower part 6c is exerted the external thrusting action, which leads the thruster organ 6 progressively to move from its initial position, opposite the entry and exit conduit 3, to its final position, proximate to the entry and exit conduit 3.

The action exerted by the user is more progressive, if the lower part 6c of the thruster organ 6 is made of a yielding elastic material. For this purpose, a material that is yieldingly elastic in natural fashion can be provided. Alternatively, a hollow case or body filled with a fluid can be provided.

The positions assumed by the thruster organ 6 are shown in the drawings. Each drawing table shows two figures relating to longitudinal sections, mutually offset by 90°, of the container according to the invention. The sections are drawn with reference with different instants in time, so that the thruster organ 6 in addition to being shown from different viewpoints, due to the 90° offset of the two sections, is also shown in different positions.

In the first longitudinal section, positioned to the left in the drawing table and designated with the letter a, the thruster organ 6 is shown in its initial position, whilst in the second longitudinal section, positioned to the right in the drawing table and designated with the letter b, the thruster organ 6 is shown in its final position. In this second longitudinal section the thruster organ 6 is drawn with dashed lines also in its initial position.

In similar fashion is also represented the deformation which the deformable hollow body 1 undergoes during the sliding of the thruster organ 6.

In the first longitudinal section, positioned to the left in the drawing table and designated with the letter a, the thruster organ 6 is shown in dashed line also in another significant position that it assumes during its intermittent sliding inside the hollow body 1. This is the position assumed an instant before a projection 10 of the thruster organ 6, conveniently provided on the upper part 6a, enters the entry and exit conduit 3.

This projection 10 enters the entry and exit conduit 3 in the final segment of the sliding run of the thruster organ 6 and is destined to thrust outside any additional residue of paste or lotion 2 and completely to empty the entry and exit conduit 3 in the entry and exit conduit 3 are collected the last residues of paste or lotion 2. They arrive in the entry and exit conduit 3 by flowing in small open channels 9 that traverse the surface of the projection 10. The presence of said channels 9 prevents the projection 10 from completely obstructing the entry and exit conduit 3 and the residues of paste or lotion 2 from being trapped between the inner walls of the hollow body 1 and the surface of the upper part 6a of the thruster organ 6.

As the thruster organ 6 approaches the entry and exit conduit 3, the space available to the paste or lotion 2 is reduced. In this case, in the absence of the channels 9, as soon as the projection 10 enters the entry and exit conduit 3, the paste or lotion 2 would be trapped. The channels 9 also extends on the surface of the upper part 6a In this way the trapping of residues of paste or lotions 2 is excluded when, in the final segment of the sliding run of the thruster organ 6, the surface of the upper part 6a and the inner walls of the hollow body 1 are extremely close.

The presence of the channels 9 on the upper part 6a, therefore, is important even in the absence of the projection 10, given that in this case they allow to accumulate the residues in the entry and exit conduit 3, wherefrom they can be in any case extracted even without the projection 10.

The shape of the individual parts 6a, 6b and 6c constituting the thruster organ 6 also depends on the type of the tube, in particular on its cross section.

The drawing tables also show a total of nine different possible examples, referring to tubes with circular cross section (tables 1/9-3/9), with square cross section (tables 4/9-6/9) and elliptical cross section (tables 7/9-9/9). This is clearly done merely by way of example and it does not exclude from the present scope of protection tubes with different cross section, such as those with rectangular, triangular or similar cross section.

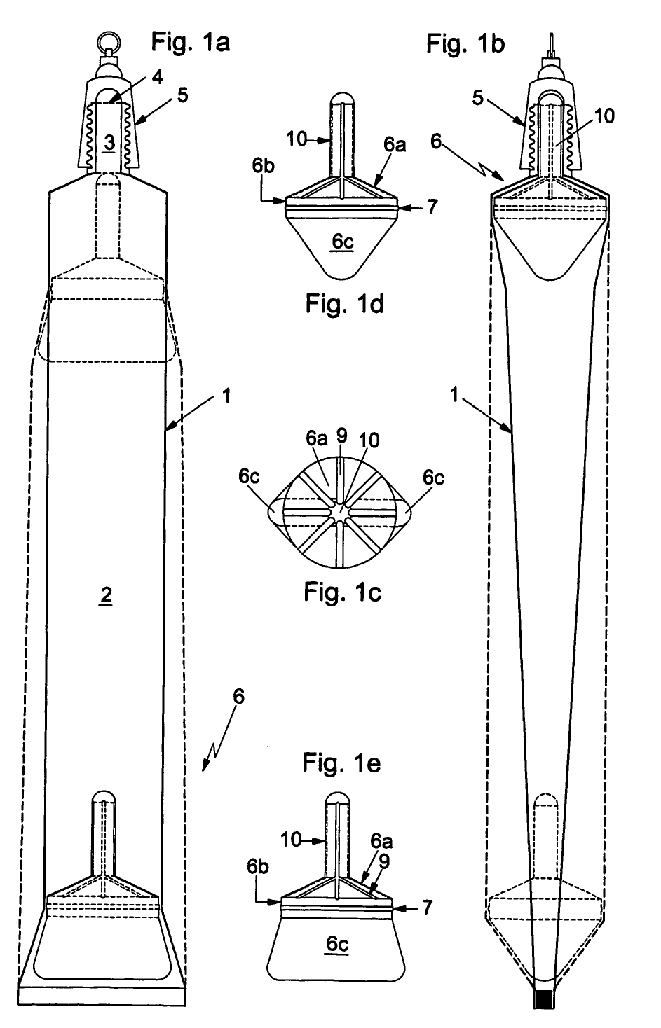

The first example of thruster organ 6 according to the invention is shown in particular in the FIGS. 1c-1e. The upper part 6a is in the shape of a cone frustum with circular cross section and is provided with the projection 10. The central part 6b is cylindrically shaped with circular cross section and has the band 7, whilst the lower part 6c has irregular shape. As shown in particular in FIG. 1c, the irregular shape of the central part 6c is the one that results by joining a lower portion thereof, with cross section of roughly elliptical shape, sharply flattened and nearly rectangular, with an upper portion thereof, with circular cross section.

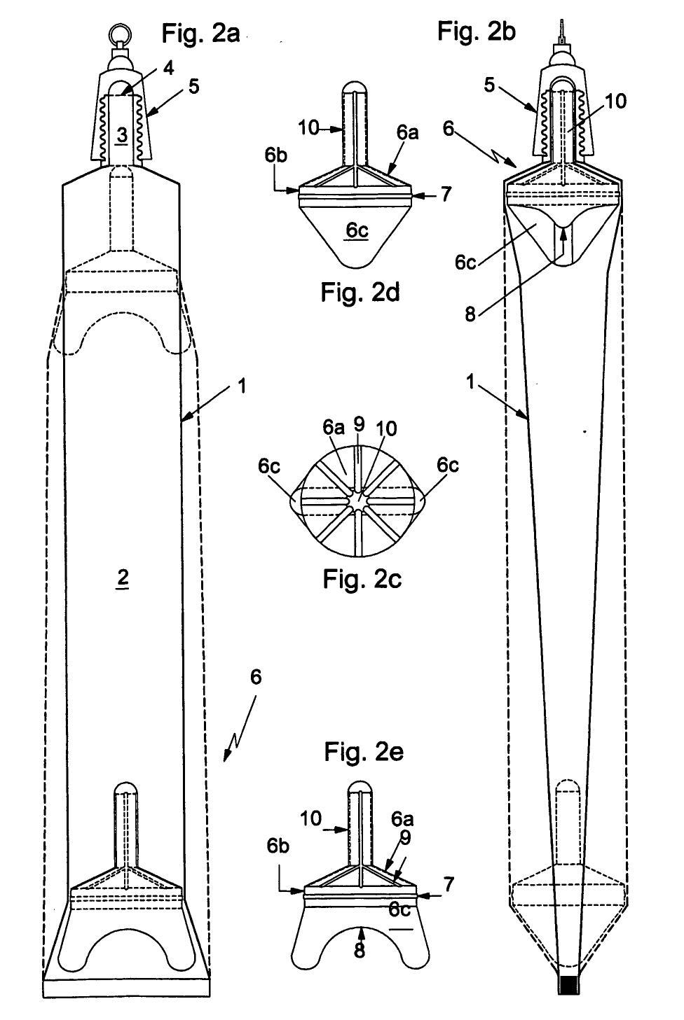

The second example of thruster organ 6 according to the invention is shown in particular in FIGS. 2c-2e. The upper part 6a and the central part 6b are identical to those of the aforementioned first example. As shown in FIGS. 2c and 2e, the lower part 6c is the one obtained by inferiorly removing material from a lower part 6c identical to the one of the aforementioned first example, to create a contoured recess 8. Said contoured recess 8 is destined to receive the user's thumb and facilitates the exercise of the external thrusting action.

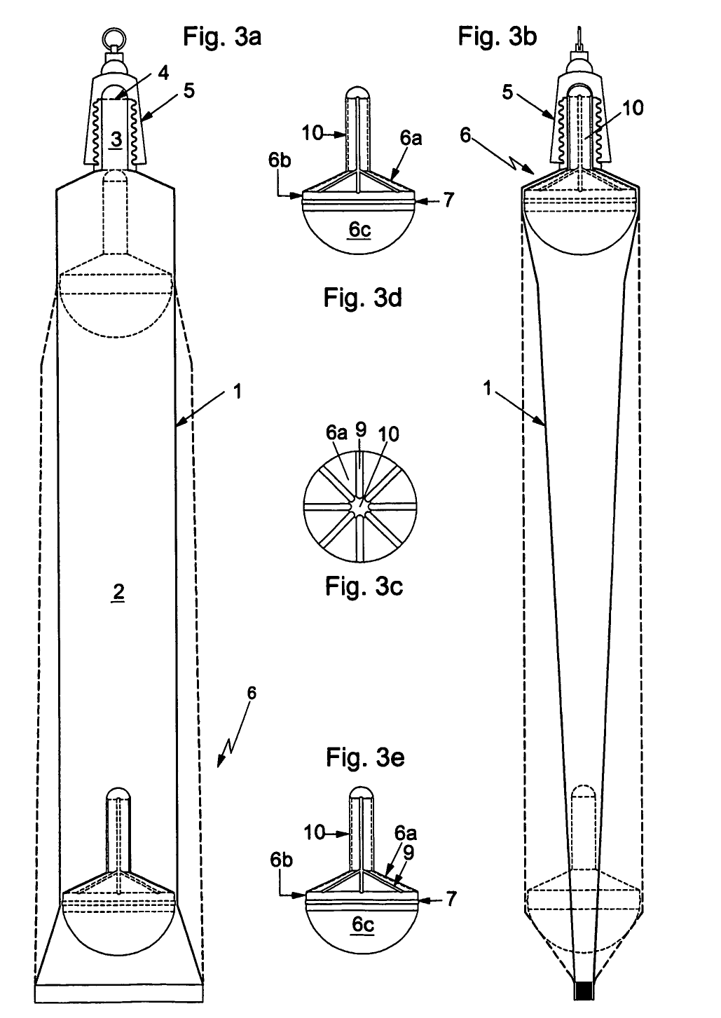

The third example of thruster organ 6 according to the invention is shown in particular in FIGS. 3c-3e. For it, too, the upper part 6a is shaped as a cone frustum with circular cross section and is provided with the projection 10, whilst the central part 6b is in the shape of a cylinder with circular cross section and has the band 7. The lower part 6c, however, is shaped as a hemisphere, so that thanks to the symmetry of this part the external thrusting action provided by the fingers of the user's hand can take place in any position, since there is no preferred direction as is the case for instance if the contoured recess 8 is present.

A fourth, a fifth and a sixth example of thruster organ 6 according to the invention are illustrated below, with reference to a tube with square cross section.

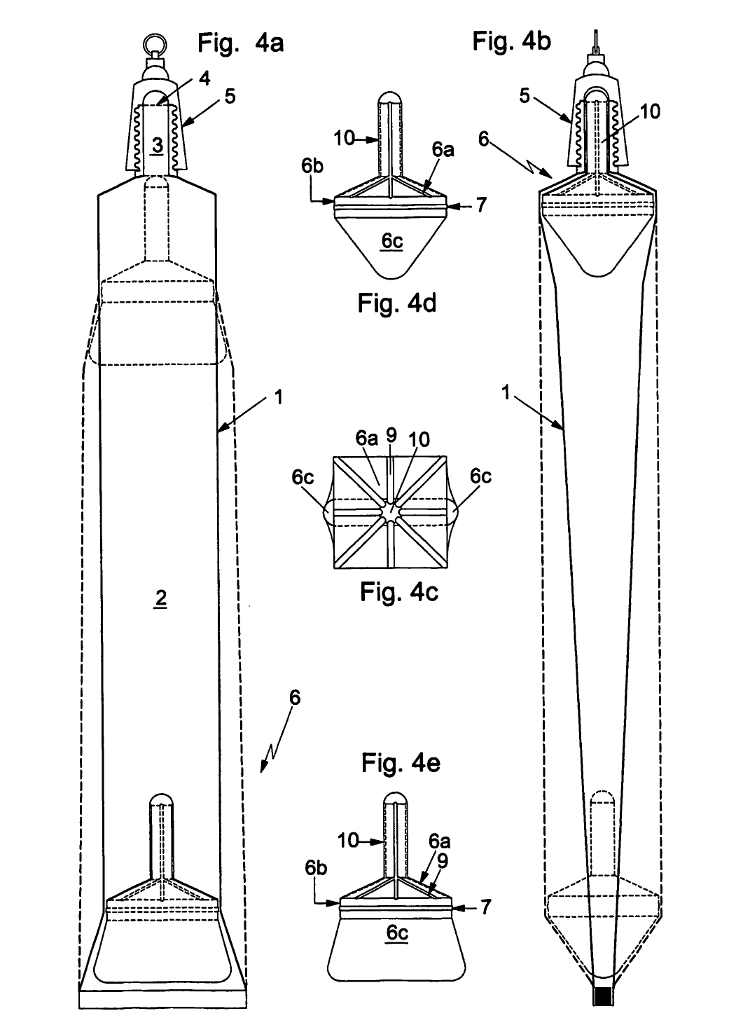

The fourth example of thruster organ 6 according to the invention is shown in particular in FIGS. 4c-4e. The upper part 6a is shaped as a cone frustum with square cross section and is provided with the projection 10. In this example the central part 6b is in the shape of a parallelepiped with square cross section and it has the band 7, whilst the lower part 6c has irregular shape. Said irregular shape is the one obtained, as shown in FIG. 4c, by joining a lower portion thereof, with roughly elliptically, highly flattened and nearly rectangular shaped cross section, with an upper part thereof, which has square cross section.

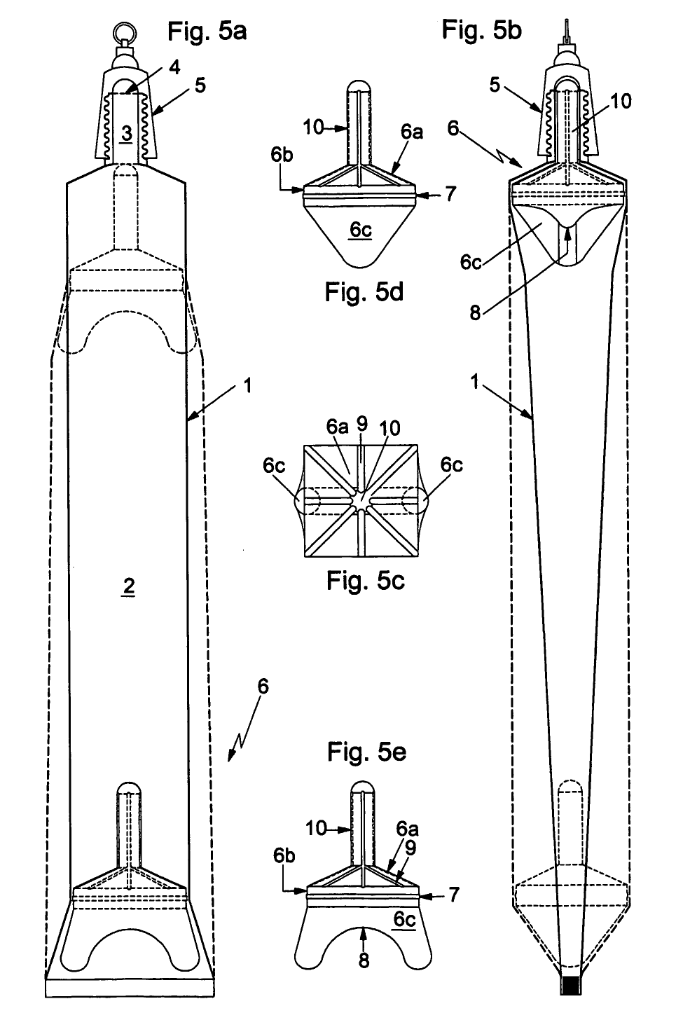

The fifth example of thruster organ 6 according to the invention is shown in particular in FIGS. 5c-5e. The upper part 6a and the central part 6b are identical to those of the aforementioned fourth example. As FIGS. 5c and 5e show, the lower part 6c is the one obtained by inferiorly removing material from a lower part 6c identical to that of the aforementioned fourth example, to create a contoured recess 8. Said contoured recess 8 is destined to receive the thumb of the user's hand and facilitates the exercise of the thrusting action.

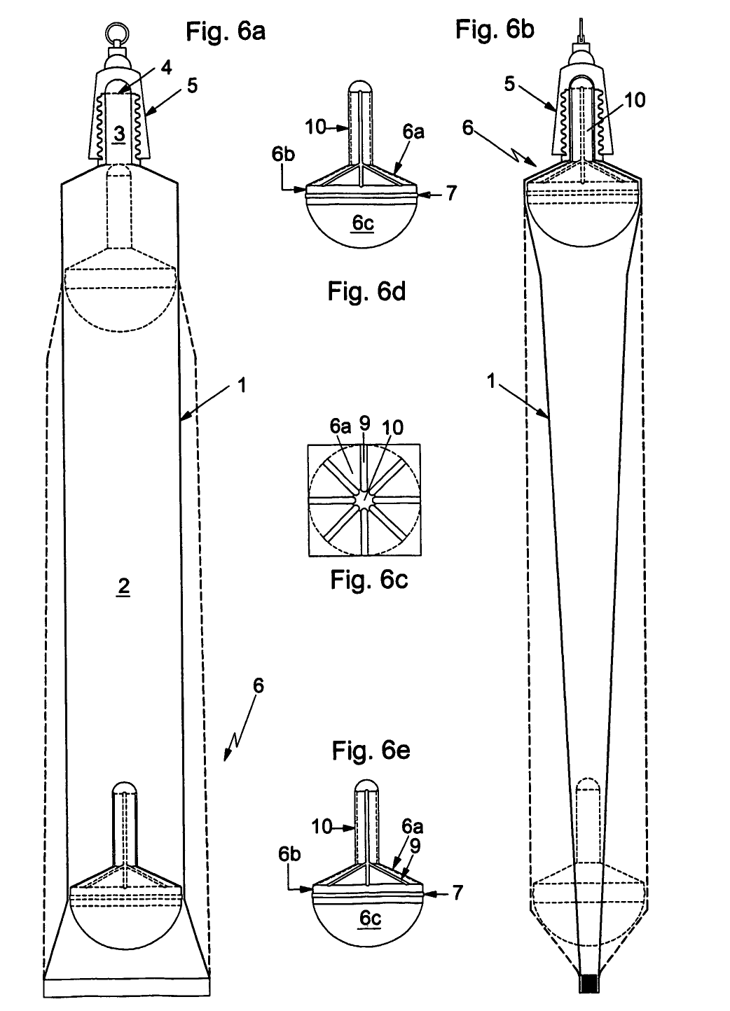

The sixth example of thruster organ 6 according to the invention is shown in particular in FIGS. 6c-6e. For it, too, the upper part 6a has cone frustum shape with square cross section and is provided with projection 10, whilst the central part 6b has parallelepiped shape and has the band 7. The lower part 6c, however, has hemispheric shape, therefore thanks to the symmetry of this part the thrusting action provided by the fingers of the user's hand can take place in any position, since there is no preferred direction as is the case for instance if the contoured recess 8 is present.

A seventh, an eighth and a ninth example of thruster organ 6 according to the invention are illustrated below, with reference to a tube with elliptical cross section.

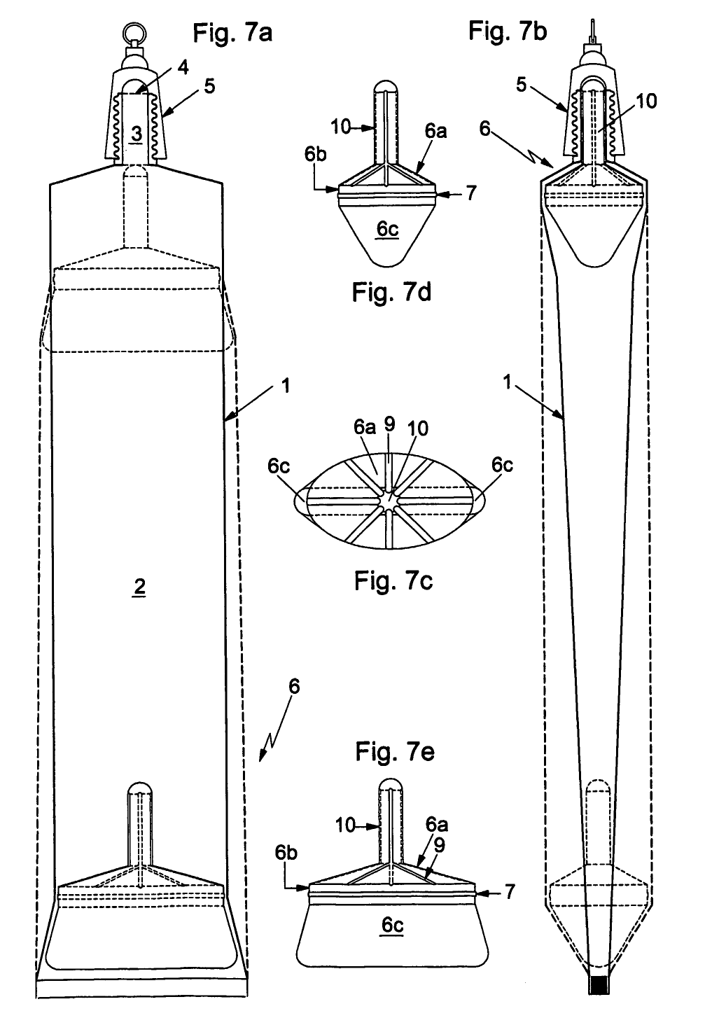

The seventh example of thruster organ 6 according to the invention is shown in particular in particular in FIGS. 7c-7e. For it, too, the upper part 6a has cone frustum shape with elliptical cross section and is provided with projection 10. In this example, the central part 6b has cylindrical shape with elliptical cross section and has the band 7, while the lower part 6c has irregular shaped. Said irregular shape is the one obtained by joining, as shown in particular in FIG. 7c, a lower part thereof, having roughly elliptical shape, highly flattened to the point of being nearly rectangular, with an upper portion thereof, with elliptical cross section.

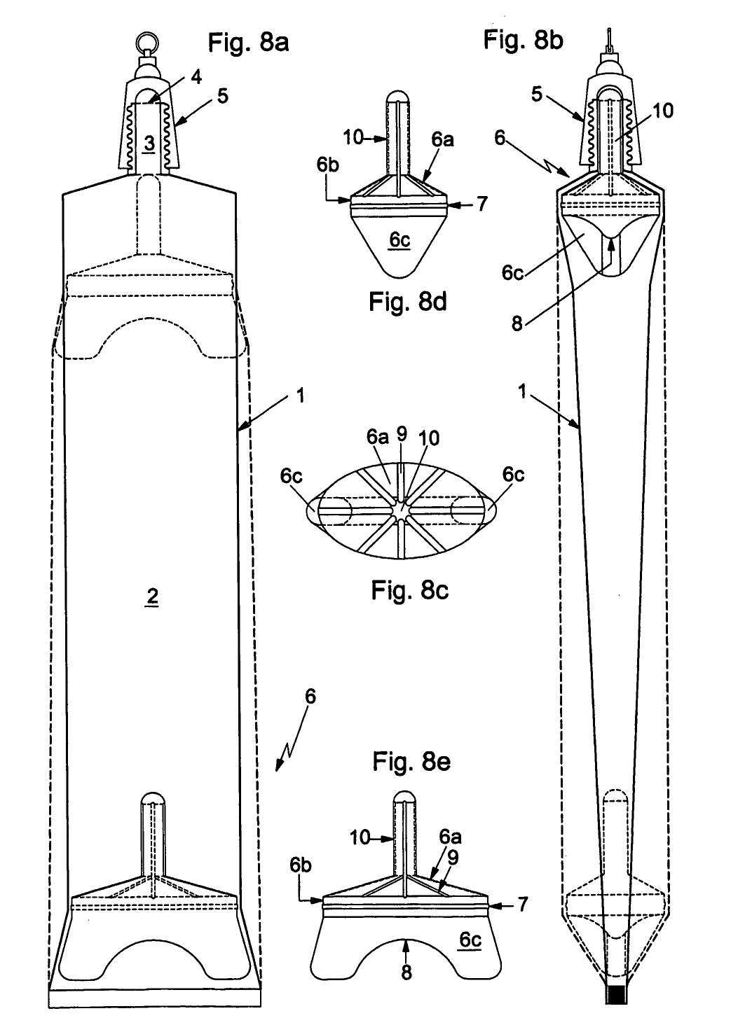

The eight example of thruster organ 6 according to the invention is shown in particular in the FIGS. 8c-8e. The upper part 6a and the central part 6b are identical to those of the aforementioned seventh example. As shown in FIGS. 7c and 7e, the upper part 6c is the one obtained by inferiorly removing the material from a lower part 6c identical to that of the aforementioned seventh example, to create a contoured recess 8. Said contoured recess 8 is destined to receive the thumb of the user's hand and facilitates the exercise of the thrusting action

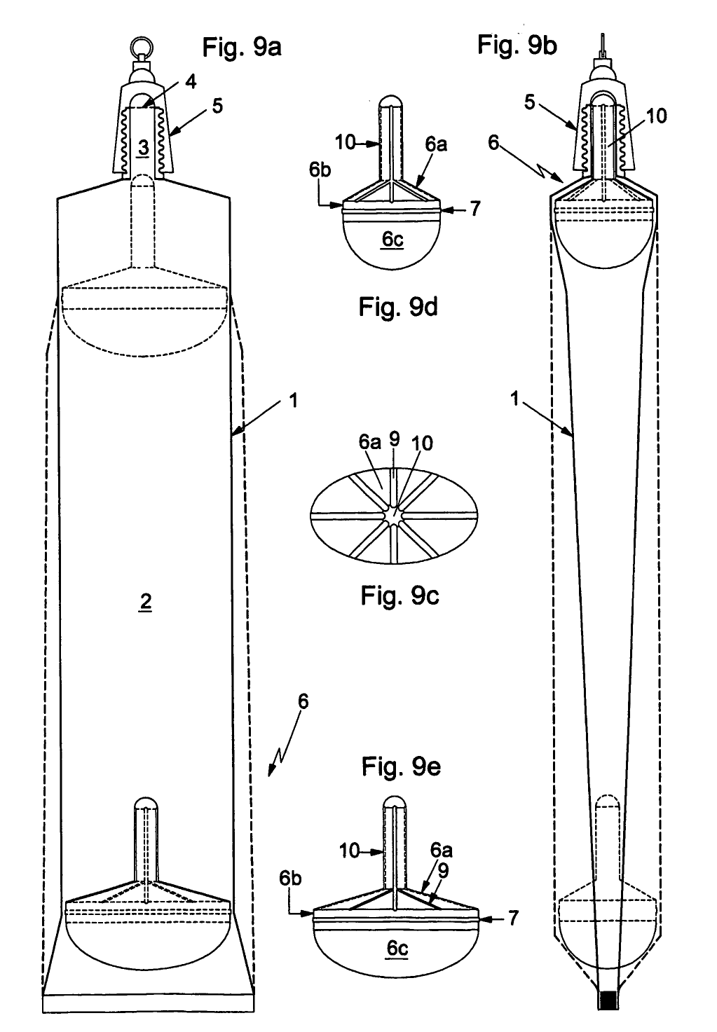

The ninth example of embodiment of the thruster organ 6 according to the invention is shown in particular in the FIGS. 9c-9e. For it too the upper part 6a is has cone frustum shape with elliptical cross section and it is provided with the projection 10, whilst the central part 6b has cylindrical shape with elliptical cross section and has the band 7. The lower part 6c, however, has semi-ellipsoid shape, so that thanks to the symmetry of this part the thrusting action provided by the fingers of the user's hand can take place in any position, since there is no preferred direction as is the case for instance if the contoured recess 8 is present.

The operation of the container according to the invention is very simple.

The user removes the closure element 5. Subsequently, (s)he presses with his/her fingers on the hollow body 1, on the area above the lower part 6c, easily recognisable at the touch.

The crushing action exerted by the fingers in turn exerts a thrusting action on the underlying thruster organ 6, in particular on the lower part 6c. As a result, the thruster organ 6 slides a certain distance towards the entry and exit conduit 3. The upper part 6a thrusts the paste or lotion 2 putting it under pressure, whilst the central part 6b, also aided by the band 7, prevents the paste or lotion 2 from escaping in the empty area of the hollow body 1, the one underlying the thruster organ 6.

Since the entry and exit opening 4 is open, a part of the paste or lotion flows out of the hollow body 1. The user will continue to press on the thruster organ 6 until the quantity of paste or lotion 2 flowed out corresponds to the amount required, whereupon (s)he will stop pressing and will close the container by reapplying the closure element 5.

When, following repeated uses, the thruster organ 6 is in the final segment of its sliding run, in proximity to the entry and exit conduit 3, and the residual lotion or paste 2 will be in the entry and exit conduit 3 and in the vicinity thereto, the user of the container according to the invention will not have to perform any particular manoeuvre to cause the residual lotion or paste to flow out.

It will be sufficient for him/her to continue pressing on the hollow body 1 and on the underlying thruster organ, until it reaches its end stop. Thrust by the pressure, the paste or lotion 2 will continue to flow until the very end in the entry and exit conduit 3, flowing in the channels 9.

The expelling action of the projection 10 then causes all residues to flow out.

1. Container for substances capable of flowing (2), such as pastes or lotions, i.e. substances which, while having a volume of their own, take on the shape of the container in which they are located, comprising:
a deformable hollow body (1), within which is positioned the substance capable of flowing (2) and which is provided with an entry and exit conduit (3) at the end of which is present an entry and exit opening (4), and
a closure clement (5), able to be coupled with the entry and exit conduit (3) to prevent the outflow of the substance capable of flowing (2), characterised in that it further comprises a thruster organ (6) positioned in the hollow body (I) in such a way that the substance capable of flowing (2) is in the space between the entry and exit opening (4) and the thruster organ (6), the thruster organ (6) being arranged without constraints in the hollow-body (1) and thus being able to slide under a thrusting action exerted from the exterior.

2. Container as claimed in claim 1, characterised in that the thruster organ (6) is in multiple parts, among them an upper part (6a), which is in contact with the overlying substance capable of flowing (2) and has its maximum cross section equal to that of the hollow body (1), and a lower part (6c), whereon the exterior thrusting action is exerted.

3. Container as claimed in claim 2, characterised in that the thruster organ (6) also has a central part (6b) with constant cross section, equal to that of the hollow body (1), on the surface of the central part (6c) being positioned a band (7) able to scrape on the inner surface of the hollow body (1) during the sliding of the thruster organ (6).

4. Container as claimed in claim 3, characterised in that the upper part (6a) has cone frustum shape, the central part (6b) has cylindrical shape with circular cross section and the lower part (6c) has irregular shape, obtained by joining a lower part thereof, whose cross section is roughly elliptical, very flattened and nearly rectangular, with an upper portion thereof with circular cross section.

5. Container as claimed in claim 4, characterised in that from the lower part (6c) is inferiorly removed material to create a contoured recess (8).

6. Container as claimed in claim 3, characterised in that the upper part (6a) has cone frustum shape with circular cross section, the central part (6b) has cylindrical shape with circular cross section and the lower part (6c) has hemispheric shape.

7. Container as claimed in claim 3, characterised in that the upper part (6a) has cone frustum shape with square cross section, the central part (6b) has parallelepiped shape with square cross section and the lower part (6c) has irregular shape, obtained by joining a lower portion thereof, whose cross section is roughly elliptical, very flattened and nearly rectangular, with an upper portion thereof, with square cross section.

8. Container as claimed in claim 7, characterised in that from the lower part (6c) is inferiorly removed material to create a contoured recess (8).

9. Container as claimed in claim 3, characterised in that the upper part (6a) has cone frustum shape with square cross section, the central part (6b) has parallelepiped shape with square cross section and the lower part (6c) has hemispheric shape.

10. Container as claimed in claim 3, characterised in that the upper part (6a) has cone frustum shape with elliptical cross section, the central part (6b) has cylindrical shape with elliptical cross section and the lower part (6c) has irregular shape, obtained by joining a lower portion thereof, whose cross section is roughly elliptical, very flattened and nearly rectangular, with an upper portion thereof, with elliptical cross section.

11. Container as claimed in claim 10, characterised in that from the lower part (6c) is inferiorly removed material to create a contoured recess (8).

12. Container as claimed in claim 3, characterised in that the upper part (6a) has cone frustum shape with elliptical cross section, the central part (6b) has cylindrical shape with elliptical cross section and the lower part (6c) has semi-ellipsoid shape.

13. Container as claimed in any of the claims from 2 through 12, characterised in that on the surface of the upper part (6a) are positioned small open channels (9), in which the substance capable of flowing (2) can flow.

14. Container as claimed in claim 13, characterised in that the upper part (6a) has in the direction of the entry and exit opening (3) a projection (10), which in the final segment of the sliding travel of the thruster organ (6) enters the entry and exit conduit (3), in such a away as to thrust outwards any additional residue of substance (2) capable of flowing present therein and in that the small open channels (9) also extend along the surface of the projection (10), in such a way that the substance (2) capable of flowing, by slowing therein, can enter the entry and exit conduit (3).

15. Container as claimed in any of the previous claims from 2 to 14, characterised in that the lower part (6c) of the thruster organ (6) is made of a yielding elastic material.
